(19) United States
(12) Patent Application Publication
(10) Pub. No.: US 2009/0253105 A1
(43) Pub. Date: Oct. 8, 2009

(54) Device for regulating eating by measuring potential

(76) Inventor: Jacques Lepine, Paris (FR)

Correspondence Address: Jacques Lepine;10 Rue D Alger, 10 Rue D Alger, Paris, FR

(21) Appl. No.: 12/227,835

(22) PCT Filed: May 11, 2007
(86) PCT No.: PCT/FR2007/000808

§ 371 Date: Nov. 28, 2008

(30) Foreign Application Priority Data
May 12, 2006 (FR) 0604201

(51) Int. Cl. G09B 19/00

(52) U.S. Cl. 434/127

(57) ABSTRACT

A device for regulating eating by measuring food intake data during meals by means of cutlery equipped with a handle and a food gripping head and by pedagogically restoring these data to the user to alter the movements and/or kinetics of his or her body during mealtimes characterized in that the food gripping head is conductive and in contact with a data processing circuit comprising a potential sensor circuit, the gripping surface of the handle being insulated from the food gripping head.

### TECHNICAL FIELD

The present invention relates to a device for regulating eating. The invention first measures characteristic mealtime times and then pedagogically restores these times to the user. The times measured are when the user brings food to the mouth using cutlery.

### BACKGROUND OF THE INVENTION

Patent PCT/FR05/01118 is known, that claims regulation of eating by measuring user movements during mealtimes and then by pedagogically restoring these movements to the user. The present invention is an invention of improvement on this patent that more precisely characterizes the technology used for capturing movement and the specific ergonomics of the measurement taking object adapted to the mixed constraints of this technology and the mealtime constraints. The invention measures mealtime kinetics, meal duration and frequency of food intake by the mouth during meals.

### DISCLOSURE OF THE INVENTION

One main object of the invention is to propose a regulating device that intervenes by taking measurements at mealtime and that restores to the consumer, during or after meals, data on eating kinetics during meals. The invention offers feedback to the consumer so that he may better understand his faults and slowly progress in his manner of eating. The feedback is carried out by means of expert software equipped with an alarm device and/or a restoration device that allows the consumer to set himself a program to progress to a better way of eating. Restoration to the user may be in real time during the meal or in non-real time after the meal.

One object of the invention is to propose an eating regulating device that is entirely reliable and that needs minimum filtering of the measured data. The measured data easily and immediately characterize the nature of the measured movements.

One object of the invention is to propose a regulating device that is light, mobile and that can be industrialized. The invention finds applications in both a line of inexpensive products, and also in a line of high-cost products.

One object of the invention is to propose a device that is practical and ergonomic to use, before mealtimes, during mealtimes and after mealtimes. Before meals, the invention is adapted equally well to transport in a handbag or a suit pocket, during meals the invention is adapted to the ergonomics of traditional cutlery, is discreet and resembles traditional cutlery and after meals the invention is adapted to cutlery that may be easily washed without damaging the device.

One object of the invention is to propose a device that communicates in such a way as to be able to easily communicate for monitoring progress, with a tutor or with other users presenting the same profile of nutrition kinetics problems.

One object of the invention is to respond to minor supporting problems for precise weight control and for life wellness, to problems that are partially medical in cases of excess weight or obesity, and lastly to problems that are completely medical in cases of deformation of the digestive system, digestive tract and esophagus, as for example in the case of preventing hiatal hernias.

In one main aspect, the invention comprises a measurement taking device that accompanies the user during mealtimes. The technology used emphasizes a particular characteristic of the human body, which is that of presenting a characteristic electric potential. In fact, the human body is a living body that from its cellular activity possesses a specific electric potential. The invention consists of connecting the end of the cutlery, which is conductive, to an electronic device housed in the handle, which process the signals and filters with a capacitive sensor the contact or the immediate proximity of the cutlery end, fork tines or spoon bowl, with the mouth or with the teeth. The cutlery handle and the cutlery shoulder are in an insulating material. Therefore, it is understood that each time the user puts the cutlery in his or her mouth, the electronic measuring circuit will pass from an open position to a closed position. Thus, the invention proposes a device for measuring the movement of bringing food to the mouth by means of cutlery.

In one aspect of the invention, the device is equipped with a data processing chip. This data processing chip is connected either to a USB type key that is removable and integrated with the cutlery handle, or to a transmitter that transmits data over a remote terminal equipped with software for processing these data. The terminal thus allows the user to analyze, during and at the end of the meal, the manner of eating, the amount of time for eating the meal and the number of strokes of the fork. This restoration may be performed by restoration means via graphic table or alarm. This restoration comes directly by an electronic circuit housed in the cutlery or by a remote terminal or through an Internet portal. The user is human or software assisted.

In one aspect, the invention also comprises a parameterable alarm system activated in real time to alert the user during the meal that he has entered a critical zone and that he must immediately modify or slow down his fork strokes, chewing or swallowing. The alarm device may be a light, a vibrator or a sound alarm.

In one particular aspect of the invention, several pieces of cutlery utilized are equipped with the present device, whether it is the fork, the spoon or various glasses. These different pieces of cutlery are all connected in a network to the same processing terminal that may thus analyze when such and such a dish or drink is put in the mouth. This manner of coupling several sensors provides more comprehensive information on the mealtime.

### DESCRIPTION OF THE DRAWINGS

The attached figures represent a particular embodiment of the invention in which:

FIG. 1 represents a general view of the eating regulating device according to the invention.

FIG. 2a represents an electronic data processing circuit according to the invention.

FIG. 2b represents a particular diagram of the electronic circuit integrating the capacitive sensor according to the invention.

FIG. 3 represents a complete set according to one aspect of the invention.

FIGS. 4a, 4b represent an assembly position in the meal position, FIG. 4a, and in the storage position, FIG. 4b.

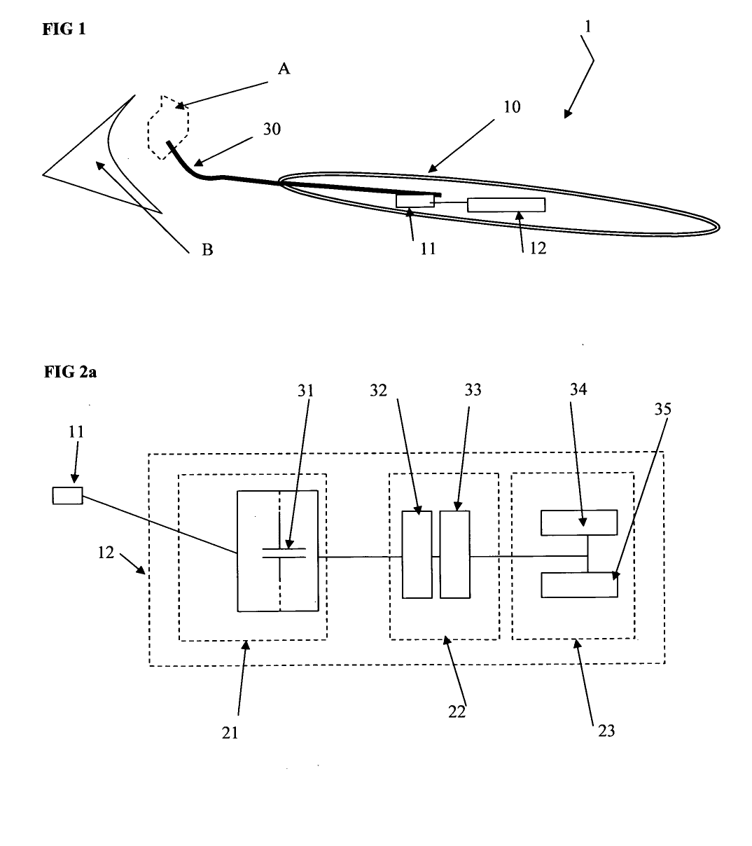

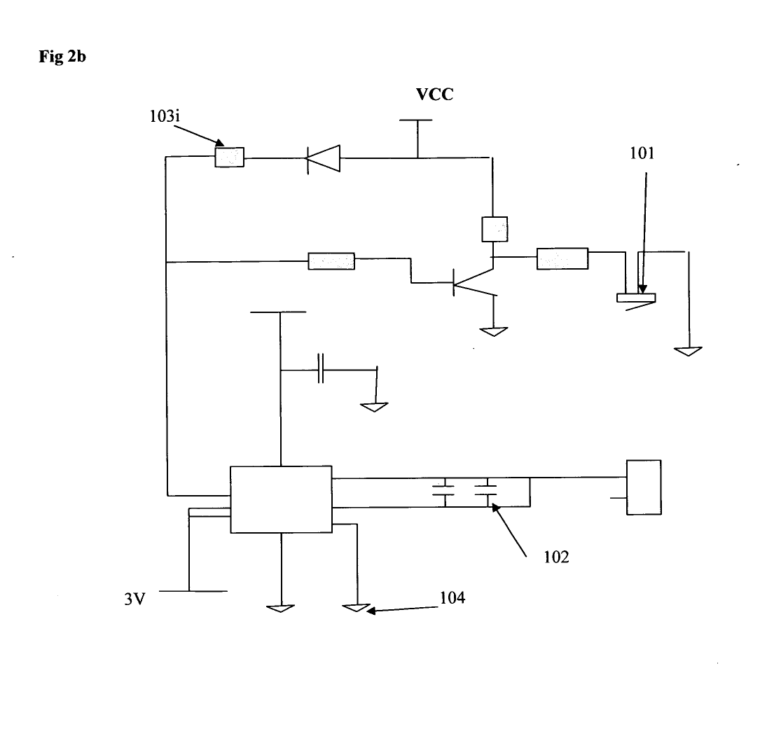

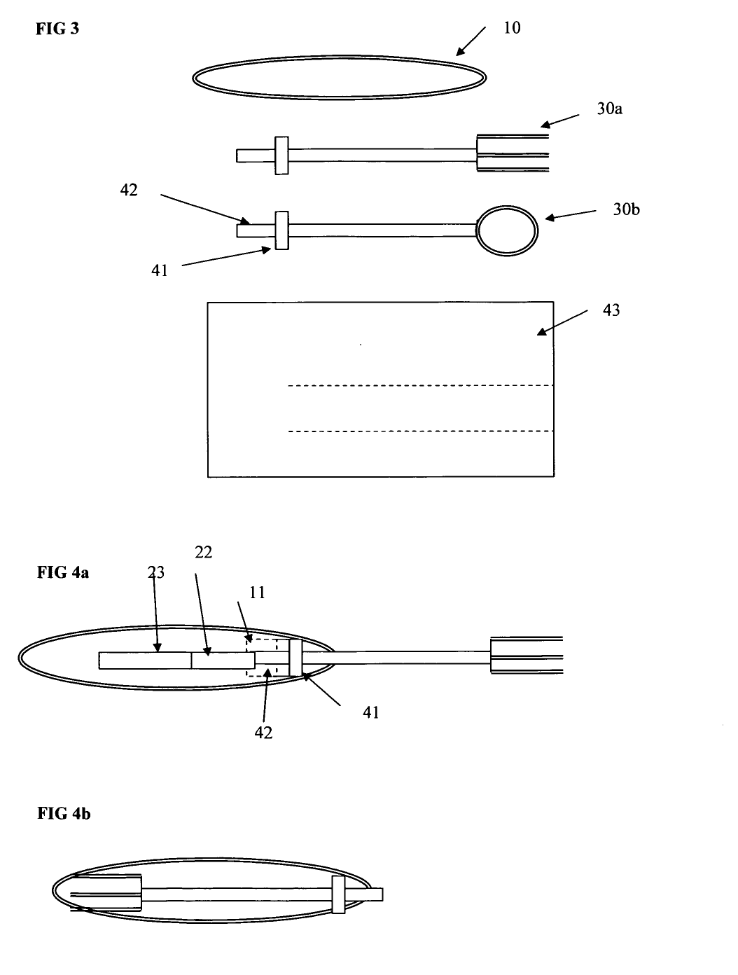

FIG. 1 represents a general view of the eating regulating device (1) according to the invention. The invention comprises a device for processing data comprising a contactor (11), an electronic processing circuit for processing data (12) more particularly described in FIG. 2 housed in a handle (10) of a piece of cutlery, a spoon, fork or glass. When the user puts food (A) in the mouth (B), the gripping head part (30) of the piece of cutlery, which are the tines (30a, FIG. 3) or a spoon bowl (30b, FIG. 3) thus are in contact with the mouth of the user. The end of the gripping head (30) of the eating regulating cutlery (1), which is conductive, is thus going to lead the current to the contactor (11) of the electronic data processing circuit (12). The handle of the cutlery (10), held in the hand of the user, is covered with an insulating material. In one aspect of the invention, it is possible that the size of the insulating material-covered handle is a little larger than the size of a traditional handle, such that, inadvertently or by a slightly unusual gripping handle position, the user does not touch the conductive part of the gripping head (30) with his fingers, and thus does not establish contact. It is therefore clear that the only part of the piece of cutlery that touches a part of the body of the user with a conductive part is the head part (30) of the piece of cutlery that is used to bring food to the mouth. FIG. 2a represents an electronic data processing circuit (12) according to the invention that comprises a capacitive circuit (21), a data processing circuit (22) and a restoring circuit (23). The capacitive circuit (21) for measuring electric potential filters the characteristic potential of the human body by means of a circuit comprising a capacitance (31). The capacitive circuit (21) for measuring is adjusted to filter only the applied potential in a range of potential specific to the human body. Thus, when the fork is in contact with food, the table or ambient air, it is not activated. The processing circuit (22) comprises a chip (32) coupled with a timer (33). The processing circuit (22) processes data correlated with food intake acts and with their times during meals to provide a series of pedagogical restoration indicators that is sent to the restoring circuit. The restoring circuit (23) comprises an alarm (35) that restores processed data to the user in real time, and a transmission device (34). The alarm (35) is parameterable to better follow the progress and morphology of the user. The transmission device (34) is of a different nature depending on the cutlery range used and may be an antenna or a USB connector. The function of the transmission device (34) is to transmit processed data to another remote terminal that will present more favorable restoration ergonomics to the user than the simple cutlery (1). The remote terminal may be a computer or a portable telephone. The processing and restoring circuit (22, 23) may also be integrated in a USB key that after the meal will be connected to a computer. From his computer, the user thus is able to read the data written on the key. The user may also parameterize the alarms from his computer. The user may also transmit data over a remote Internet portal. FIG. 2b represents a particular diagram of the electronic circuit integrating the capacitive sensor according to the invention, that comprises a sound alarm (101), resistors (103i), capacitances (102), and ground connections (104). FIG. 3 represents a complete set according to one aspect of the invention, such as may be presented to the user at the time of purchase. This aspect comprises a cutlery cover (10) that comprises the electronic circuit, and two pieces of cutlery including a fork (30a) and a spoon (30b). The lengths of the fork (30a) and spoon (30b) are shorter than the length of a traditional fork or spoon inasmuch as they are in contact along their ends of the handle (42) with the contactor (11) inside and in the middle of the handle (10). The pieces of cutlery (30) are maintained inside the handle by means of an articulated connection (42) that allows the piece of cutlery to be pivoted from a meal position, FIG. 4a, to a storage position, FIG. 4b. The cutlery heads (30) are thus removable so as to be able to be easily cleaned after meals. The handle itself is simply wiped gently, thus preventing the electronics from being damaged by water. The invention also proposes a storage sack or case (43) equipped with various storage pockets. Thus, in the storage position, the case will comprise the electronic processing handle (10) and a set of removable cutlery heads (30). A removable USB key (22, 23) may be integrated into the body of the cutlery handle.

### CONCLUSION

The invention thus relates to a device for regulating eating by measuring food intake data during meals, by means of cutlery (1) equipped with a handle (10) and a food gripping head (30) and by the pedagogic restoration of these data to the user to alter the movements and/or kinetics of his body during mealtimes characterized in that the food gripping head (30) is conductive and in contact (11) with a data processing circuit (12) comprising a potential sensor circuit (21), the gripping surface of the handle (10) being insulated from the food gripping head (30).

The invention thus relates to an eating regulating device characterized in that the piece of cutlery (1) is a fork or a spoon.

The invention thus relates to an eating regulating device characterized in that the insulated surface of the handle also comprises the shoulder of the piece of cutlery in the immediate proximity of the fork tines or the spoon bowl.

The invention thus relates to an eating regulating device characterized in that the electronic data processing circuit (12) comprises a sensor circuit integrating a capacitive circuit (21), a circuit for processing captured data (22) and a circuit for restoring processed data (23).

The invention thus relates to an eating regulating device characterized in that the capacitive circuit (21) for measuring electric potential filters the characteristic potential of the human body by means of a circuit comprising a capacitance (31) and is adjusted to filter only the applied potential in a range of potential specific to the human body, the processing circuit (22) comprises a chip (32) coupled to a timer (33), the processing circuit (22) processes data correlated with food intake acts and with their times during meals to provide a series of pedagogical restoration indicators that it sends to the restoring circuit and the restoring circuit (23) comprises an alarm (35) that restores food intake pedagogy to the user on the processed data.

The invention thus relates to an eating regulating device characterized in that the restoring circuit (23) comprises a transmission device (34) whose function is to transmit and interface processed data with another remote terminal, the transmission device (34) either being integrated with a USB key, or integrating a wireless dialogue technology of the radio wave type operating or not operating over a BLUETOOTH type protocol.

The invention thus relates to an eating regulating device characterized in that the invention is provided with a cutlery handle (10) that comprises the electronic circuit, and two pieces of cutlery including a fork (30a) and a spoon (30b), the lengths of the fork (30a) and the spoon (30b) being shorter than the length of a traditional fork or spoon inasmuch as they are in contact along their handle ends (42) with the contactor (11) inside and in the middle of the handle (10).

The invention thus relates to an eating regulating device characterized in that the pieces of cutlery (30) are maintained inside the handle by means of an articulated connection (42) that allows the piece of cutlery to pivot from a meal position to a storage position, the heads of the cutlery (30) thus being removable so as to be able to be easily cleaned after meals.

It is thus clearly understood that numerous variations of the invention may be in line with the present invention.

What I claim is:

1. A device for regulating eating by measuring food intake data during meals, by means of cutlery (1) equipped with a handle (10) and with a food gripping head (30) and by pedagogically restoring these data to the user to alter the movements and/or kinetics of his body during mealtimes characterized in that the food gripping head (30) is conductive and in contact (11) with a data processing circuit (12) comprising a potential sensor circuit (21) characteristic of the human body, the gripping surface of the handle (10) being insulated from the food gripping head (30).

2. The eating regulating device according to claim 1 characterized in that the piece of cutlery (1) is a fork or a spoon.

3. The eating regulating device according to claim 2 characterized in that the insulated surface of the handle also comprises the shoulder of the piece of cutlery in the immediate proximity of the tines of the fork or the bowl of the spoon.

4. The eating regulating device according to claim 1 characterized in that the electronic data processing circuit (12) comprises a sensor circuit integrating a capacitive circuit (21), a circuit for processing captured data (22) and a circuit for restoring processed data (23).

5. The eating regulating device according to claim 4 characterized in that the capacitive circuit (21) for measuring electric potential filters the characteristic potential of the human body by means of a circuit comprising a capacitance (31) and is adjusted to only filter the applied potential in a potential range specific to the human body, the processing circuit (22) comprises a chip (32) coupled to a timer (33), the processing circuit (22) processes data correlated with food intake acts and with their times during meals to provide a series of pedagogical restoration indicators that it sends to the restoring circuit, the restoring circuit (23) comprises an alarm (35) that restores food intake pedagogy to the user on the processed data.

6. The eating regulating device according to claim 5 characterized in that the restoring circuit (23) comprises a transmission device (34) whose function is to transmit and interface the processed data with another remote terminal, the transmission device (34) being either integrated into a USB key, or integrating a wireless dialogue technology of the radio wave type operating or not operating over a BLUETOOTH type protocol.

7. The eating regulating device according to claim 1 characterized in that the invention is provided with a cutlery handle (10) that comprises the electronic circuit, and two pieces of cutlery, including a fork (30a) and a spoon (30b), the lengths of the fork (30a) and the spoon (30b) being shorter than the length of a traditional fork or spoon inasmuch as they are in contact along their handle ends (42) with the contactor (11) inside and in the middle of the handle (10).

8. The eating regulating device according to claim 1 characterized in that the pieces of cutlery (30) are maintained inside the handle by means of an articulated connection (42) that allows the piece of cutlery to be pivoted from a meal position to a storage position, the cutlery heads (30) thus being removable so as to be able to be easily cleaned after the meal.
